(19) United States
(12) Patent Application Publication
(10) Pub. No.: US 2003/0126969 A1
(43) Pub. Date: Jul. 10, 2003

(54) Table saw capable of adjusting cutting angle

(76) Inventor: Nick Chen, Taichung (TW)

Correspondence Address: BROWDY AND NEIMARK, P.L.L.C., 624 NINTH STREET, NW, SUITE 300, WASHINGTON, DC, 20001-5303, US

(21) Appl. No.: 10/041,599

(22) Filed: Jan. 10, 2002

(51) Int. Cl. B27B 21/00

(52) U.S. Cl. 83/764; 83/758; 83/762; 83/781; 83/783

(57) ABSTRACT

A table saw capable of adjusting its cutting angle comprises a base, a suspension arm pivotally mounted on said base and provided at two distal ends thereof with a mounting seat respectively, two adjustment members detachably fastened to mounting seat respectively, four support rods connected to said two adjustment members respectively, two saw racks sleeved onto said four support rods respectively, and an arch saw movably installed in said saw racks for reciprocating motion between said saw racks within a distance. The mounting seats each has a mounting hole and a first positioning unit below the mounting hole. The adjustment members each has a second positioning unit adapted for coupling to the first positioning unit for enabling said adjustment member to be secured to the mounting seat in a determined posture, and a through hole above the second positioning unit, through which a screw bolt is inserted and fastened to the mounting hole of the corresponding mounting seat.

### FIELD OF THE INVENTION

The present invention relates generally to a table saw, and more particularly to the table saw capable of adjusting its cutting angle.

### BACKGROUND OF THE INVENTION

During wood working, different table saws may be used to cut wooden materials at different angles. In order to fit different cutting angles, the angular position of the saw of a table saw must be adjustable. FIG. 1 illustrates an angle-adjustable table saw, which was an invention of the present inventor.

### SUMMARY OF THE INVENTION

The primary objective of the present invention is to provide a table saw capable of adjusting its cutting angle, which enables the user to adjust the cutting angle of the saw easily and accurately.

To achieve the objective of the present invention, the table saw comprises a base, an elongated suspension arm, two adjustment members, four support rods, two saw racks, and an arch saw. The base has a cutting portion and a retaining portion disposed below said cutting portion. The suspension arm is pivoted to a bottom side of said cutting portion of said base and disposed substantially in parallel to said cutting portion for free rotation. The suspension arm has a coupling portion adapted for fastening to the retaining portion of said base, and two mounting seats at two distal ends thereof. The mounting seats each has a mounting hole and a first positioning unit below the mounting hole. The two adjustment members are respectively mounted on the mounting seats of said suspension arm, said adjustment members each having a second positioning unit adapted for coupling to the first positioning unit of said mounting seat of said suspension arm for enabling said adjustment member to be secured to the mounting seat of said suspension arm, and a through hole transversely extended through two opposite sides thereof above the second positioning unit, through which a screw bolt is inserted and fastened to the mounting hole of the corresponding mounting seat of said suspension arm. The four support rods are arranged in two sets and respectively fastened to said adjustment members. The two saw racks are respectively sleeved onto said support rods. The arch saw is movably installed in said saw racks for reciprocating motion between said saw racks within a distance.

### BRIEF DESCRIPTION OF THE DRAWINGS

FIG. 1 is a perspective view of a table saw of a prior art.

FIG. 2 is a side view of a preferred embodiment of the present invention.

FIG. 3 is a perspective view of the suspension arm of the preferred embodiment of the present invention.

FIG. 4 is a left side view of one mounting seat of the suspension arm of the present invention.

FIG. 5 is a front view of one adjustment member of the preferred embodiment of the present invention.

FIG. 6 is a rear side view of the adjustment member of the preferred embodiment of the present invention.

FIG. 7 is a top view of the adjustment member of the preferred embodiment of the present invention.

FIG. 8 is a side view of the adjustment member of the preferred embodiment of the present invention.

FIG. 9 is a side view of the preferred embodiment of the present invention showing the adjustment members fastened to the suspension arm.

FIG. 10 is a sectional view taken along line 10-10 as shown in FIG. 9.

FIG. 11 is a schematic drawing showing the angular position of the adjustment member adjusted relative to the corresponding mounting seat according to the preferred embodiment of the present invention.

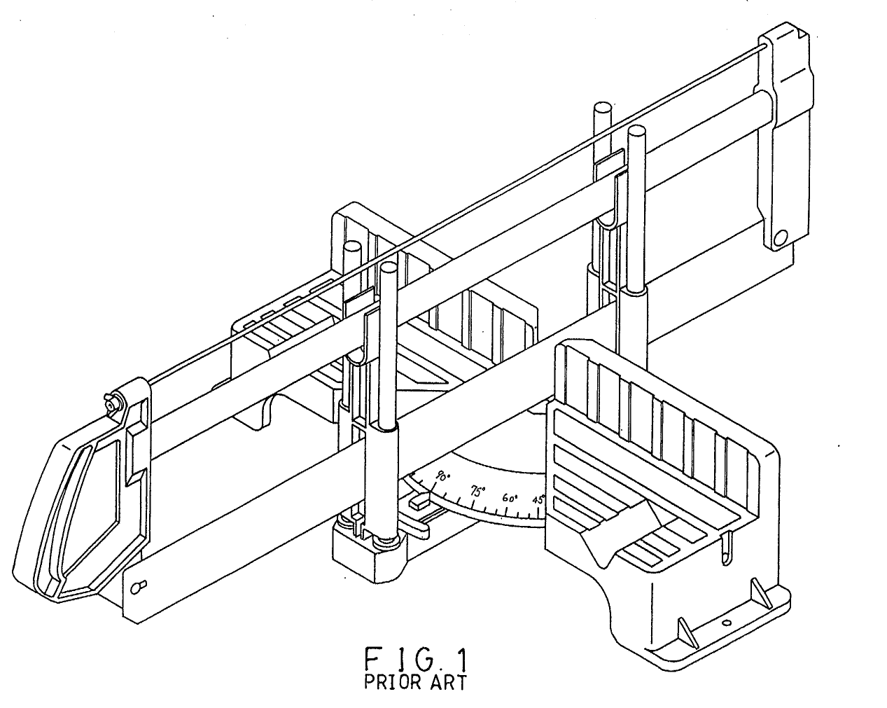

### DETAILED DESCRIPTION OF THE INVENTION

Referring to FIGS. from 2 through 4, the table saw of the preferred embodiment of the present invention is shown comprising an elongated base 10, an elongated suspension arm 20, two adjustment member 30, four support rods 40, two saw racks 50, and an arch saw 60.

The elongated base 10 is adapted for supporting the table saw on a flat surface. The elongated base 10 comprises a sector-like cutting portion 11 marked with graduations, a sector-like retaining portion (not shown) below the sector-like cutting portion 11, and a fence 12 disposed along one long side of the suspension arm. The fence 12 has an opening corresponding to the sector-like cutting portion 11.

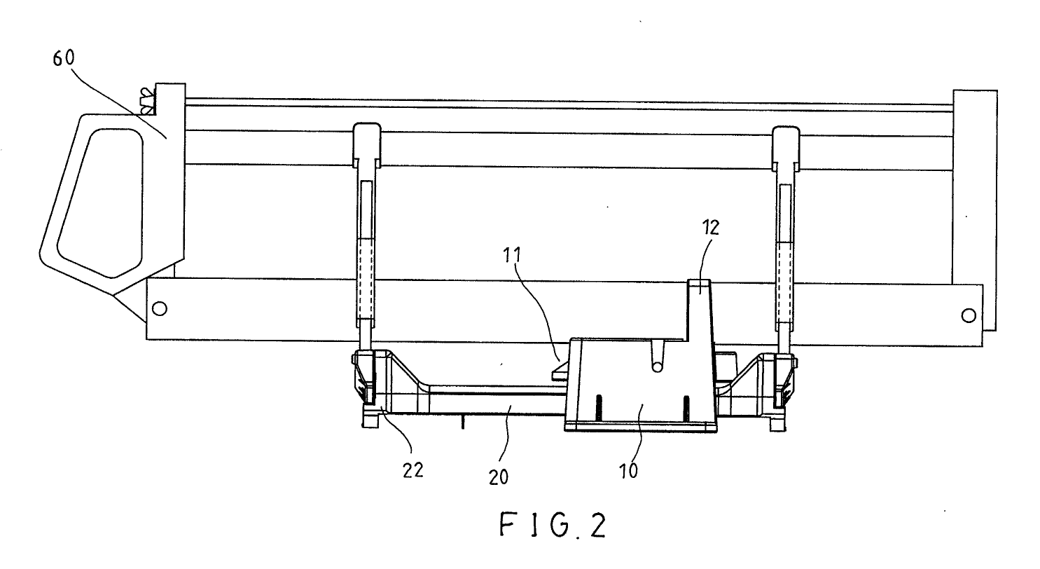

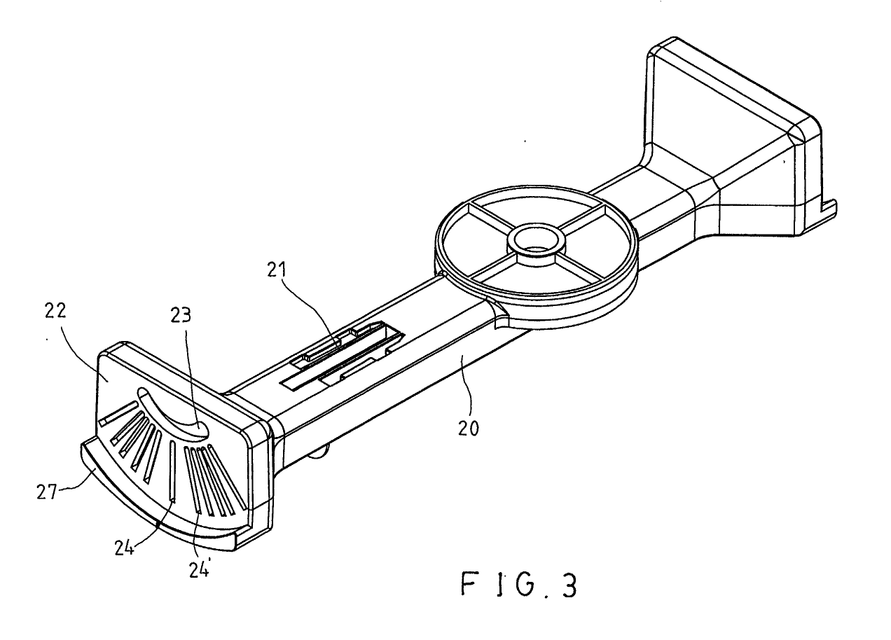

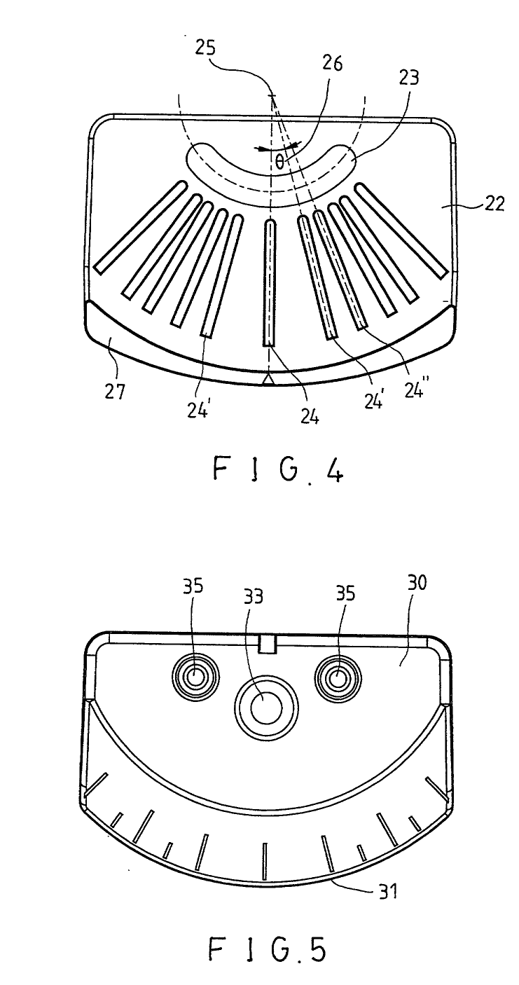

As shown in FIGS. 2-4, the elongated suspension arm 20 is pivoted to the bottom of the sector-like cutting portion 11 of the base 10 and disposed substantially in parallel to the sector-like cutting portion 11 for free rotation. The suspension arm 20 comprises a coupling portion 21 adapted for fastening to the retaining portion at the bottom side of the sector-like cutting portion 11 of the base 10, and two mounting seats 22 at two distal ends thereof. Each mounting seat 22 has a mounting hole, for example, an arched elongated mounting hole 23, an arched fender 27 protruded from the bottom side in parallel to the arched mounting hole 23, and a first positioning unit comprising a vertical elongated center locating slot 24 and radial tilted locating slots 24′, 24″ spaced between the arched mounting hole 23 and the arched fender 27. These locating slots 24, 24′, 24″ have the same shape and size. In addition, the arched slot 23, the locating slots 24, 24′, 24″ and the arched fender 27 have a common imaginary center of circle 25. The tilted locating slots 24′, 24″ are symmetrically disposed at two sides of the center locating slot 24. The contained angle θ 26 between the center locating slot 24 and each first tilted side locating slot 24′ is 15°, and the contained angle θ 26 between the vertical center locating slot 24 and each second titled side locating slot 24′ is 30°.

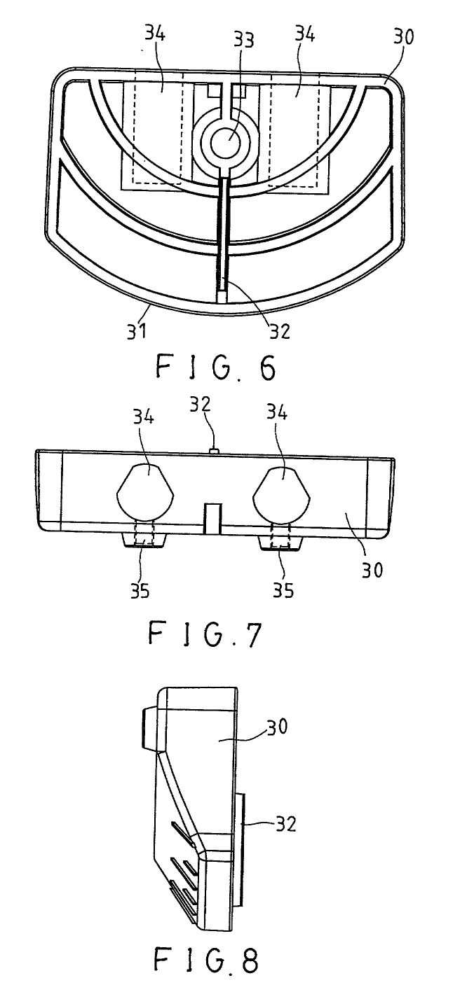

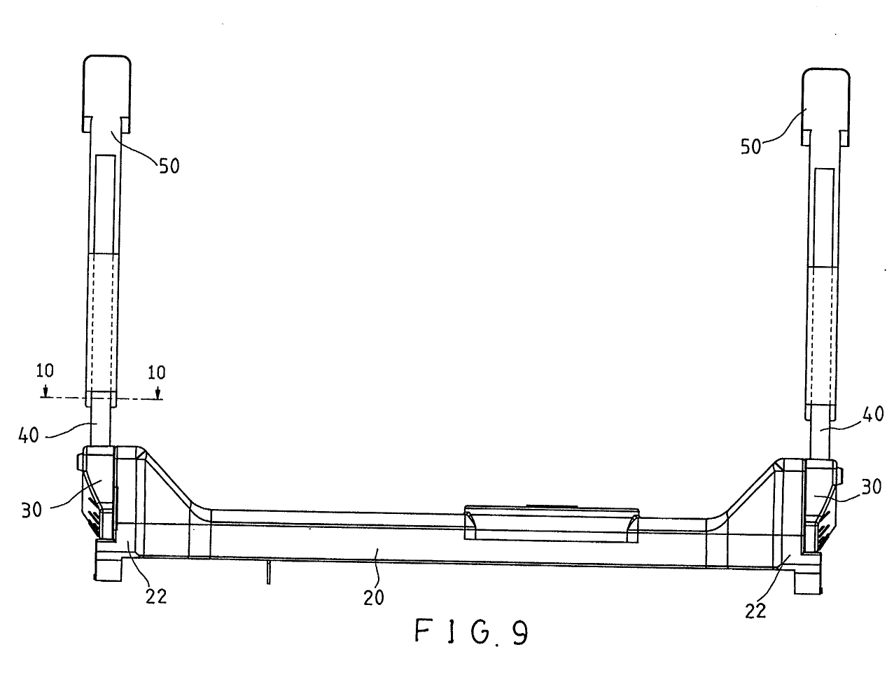

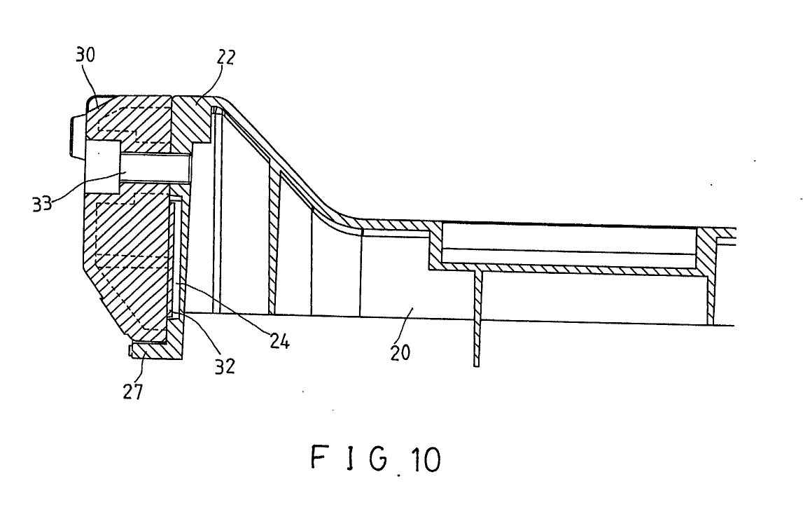

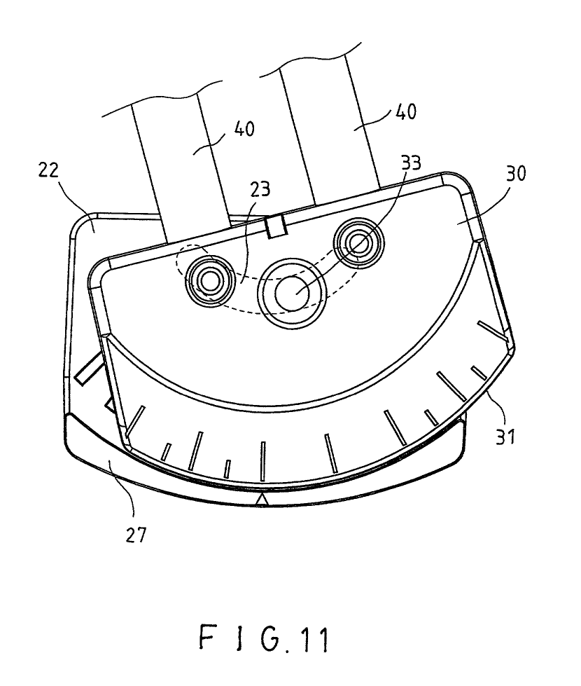

As shown in FIGS. 5-10, the two adjustment members 30 are respectively mounted on the mounting seats 22 of the suspension arm 20. Each adjustment member 30 comprises a smoothly arched bottom face 31 fitting the arched fender 27 of the corresponding mounting seat 22, a second positioning unit, for example, elongated locating rib 32 adapted for engaging into one locating slot 24, 24′ or 24″ of the corresponding mounting seat 22, a through hole 33 transversely extended through two opposite sides of the adjustment member above the locating rib 32, through which a screw bolt is inserted and fastened to the arched mounting hole 23 of the corresponding mounting seat 22, two top plug holes 34 bilaterally disposed above the through hole 33, and two screw holes 35 disposed in parallel to the through hole 33 and respectively perpendicularly extended from the plug holes 34 for the mounting of a respective tightening up screw.

The four support rods 40 are arranged in two sets and respectively plugged into the plug holes 34 of the adjustment members 30 and fixedly secured in place by tightening up screws being threaded into the screw holes 35 of the adjustment members 30.

The two saw racks 50 are respectively sleeved onto the support rods 40.

The arch saw 60 is movably installed in the saw racks 50 and reciprocated between the saw racks 50 within a distance.

The cutting action of the present invention is similar to the prior art saw table. When adjusting the cutting angle, remove the arch saw 60 from the saw racks 50, and then loosen the tightening up screws from the screw holes 35 of the adjustment members 30 for enabling the adjustment members 30 to be turned sideways relative to the mounting seats 22 to shift the locating rib 32 of each adjustment member 30 from the center radial locating slot 24 to another radial locating slot 24′, and then the tightening up screws are respectively fastened tight in the screw holes 35 of the adjustment members 30 to hold down the adjustment members 30 in the adjusted angular position. After adjustment, the arch saw 60 is coupled to the saw racks 50 again. After installation, the angular position of the arch saw 60 has been changed from the vertical cutting position to a 15°-tilted cutting position.

By means of controlling the engagement between the locating rib 32 and the locating slots 24, 24′ and 24″, the angular position of the arch saw 60 could easily accurately be adjusted.

What is claimed is:

1. A table saw comprising:
a base for supporting on a flat surface, said base having a cutting portion, a retaining portion disposed below said cutting portion, and a fence disposed along one long side thereof, said fence having an opening corresponding to said cutting portion;
an elongated suspension arm pivoted to a bottom side of said cuffing portion of said base and disposed substantially in parallel to said cutting portion for free rotation, said suspension arm having a coupling portion adapted for fastening to the retaining portion of said base, and two mounting seats at two distal ends thereof, said mounting seats each having a mounting hole and a first positioning unit below the mounting hole;
two adjustment members respectively mounted on the mounting seats of said suspension arm, said adjustment members each having a second positioning unit adapted for coupling to the first positioning unit of said mounting seat of said suspension arm for enabling said adjustment member to be secured to the mounting seat of said suspension arm, and a through hole transversely extended through two opposite sides thereof above the second positioning unit, through which a screw bolt is inserted and fastened to the mounting hole of the corresponding mounting seat of said suspension arm;
four support rods arranged in two sets and respectively fastened to said adjustment members;
two saw racks respectively sleeved onto said support rods; and
an arch saw movably installed in said saw racks for reciprocating motion between said saw racks within a distance.

2. The table saw as defined in claim 1, wherein the first positioning unit of each mounting seat of said suspension arm comprises a vertical center locating slot and a plurality of tilted side locating slots disposed at two sides of said vertical center locating slot, said vertical center locating slot and said tilted side locating slots having an imaginary common center of circle, said tilted side locating slots defining with said vertical center locating slot a respective contained angle.

3. The table saw as defined in claim 2, wherein said second positioning unit of each of said adjustment members is a locating rib adapted for engaging into one of the vertical center locating slot and side locating slots of the corresponding mounting seat.

4. The table saw as defined in claim 2, wherein the mounting hole of each mounting seat of said suspension arm is an arched elongated mounting hole.

5. The table saw as defined in claim 4, wherein the center of circle of the arched mounting hole of each mounting seat of said suspension arm is the imaginary center of circle of the vertical center locating slot and tilted side locating slots of the respective mounting seat.

6. The table saw as defined in claim 2, wherein each mounting seat of said suspension arm has an arched fender at a bottom side, said arched fender having a center of circle identical to said imaginary center of circle.

7. The table saw as defined in claim 6, wherein said adjustment members each comprise a smoothly arched bottom face fitting the arched fender of the corresponding mounting seat of said suspension arm.

8. The table saw as claimed in claim 1, wherein said adjustment members each comprises tow top plug holes adapted for receiving said support rods, and two screw holes respectively perpendicularly extended from said top plug holes to one side thereof for the mounting of two tightening up screws to fix the respective support rods in said plug holes.
